(19) United States
(12) Patent Application Publication
(10) Pub. No.: US 2008/0019310 A1
(43) Pub. Date: Jan. 24, 2008

(54) Apparatus, method and computer program product providing anytime preemptive re-transmissions

(75) Inventors: Guillaume Sebire, Espoo (FI); Tommi Jokela, Helsinki (FI); David Navratil, Helsinki (FI)

Correspondence Address: HARRINGTON & SMITH, PC, 4 RESEARCH DRIVE, SHELTON, CT, 06484-6212, US

(73) Assignee: Nokia Corporation

(21) Appl. No.: 11/820,742

(22) Filed: Jun. 19, 2007

Related U.S. Application Data
(60) Provisional application No. 60/815,065, filed on Jun. 19, 2006.

(51) Int. Cl. H04Q 7/00

(52) U.S. Cl. 370/329

(57) ABSTRACT

The exemplary embodiments of this invention provide apparatus, methods and computer program products that enable a transmitter to preemptively re-transmit data blocks (e.g., RLC/MAC blocks) without relying on acknowledgment information from the receiver. In one exemplary, non-limiting embodiment, a method includes: determining whether at least one criterion is fulfilled; transmitting a data block to a receiver; and in response to determining that the at least one criterion is met, preemptively re-transmitting the data block to the receiver. In further exemplary embodiments, preemptively re-transmitting the data block involves using one of a consecutive re-transmission scheme or a parallel re-transmission scheme.

### CROSS-REFERENCE TO RELATED APPLICATIONS

This patent application claims priority under 35 U.S.C. §119(e) from Provisional Patent Application No. 60/815,065, filed Jun. 19, 2006, the disclosure of which is incorporated by reference herein in its entirety.

### TECHNICAL FIELD

The exemplary embodiments of this invention relate generally to wireless communications systems, methods, devices and computer program products and, more specifically, relate to GERAN GPRS and (E)GPRS capable systems, methods, devices and computer program products.

### BACKGROUND

The following abbreviations are herewith defined:

3GPP third generation partnership project

ACK acknowledgement

AGCH access grant channel

BCCH broadcast control channel

BLER block error rate

BSN block sequence number

BSS base station system

EDGE enhanced data rates for global evolution

(E)GPRS enhanced GPRS

FACCH fast associated control channel

GERAN GSM/EDGE radio access network

GMMRR GMPRS mobility management radio resource

GMPRS geo-mobile packet radio service

GPRS general packet radio services

GRR GPRS radio resource

GSM global system for mobile communications

LLC link layer control

MAC medium access control

MM mobility management

MS mobile station

NACK negative acknowledgement

PACCH packet associated control channel

PAGCH packet access grant channel

PBCCH packet broadcast control channel

PCCCH packet common control channel

PCH paging channel

PD protocol discriminator

PDCH packet data channel

PDTCH packet data traffic channel

PDU protocol data unit

PPCH packet paging channel

PRACH packet random access channel

RACH random access channel

RLC radio link control

RR radio resource

SACCH slow associated control channel

SAP service access point

SAPI service access point identifier

SDCCH stand-alone dedicated control channel

TBF temporary block flow

TTI transmission timing interval

USF uplink state flag

VoIP voice over internet protocol

Reference with regard to the subject matter discussed herein may generally be made to the following publications:

3GPP TS 44.060, V7.4.0, “3rd Generation Partnership Project; Technical Specification Group GSM/EDGE Radio Access Network; General Packet Radio Service (GPRS); Mobile Station (MS)-Base Station System (BSS) interface; Radio Link Control/Medium Access Control (RLC/MAC) protocol (Release 7),” May 2006;

3GPP TSG GERAN2#29bis Tdoc G2-060184, 5.3.3.2, “A performance evaluation of short ACK/NACK reports in varying traffic scenarios,” Ericsson, Sophia Antipolis, France, May 22-24, 2006;

3GPP TSG GERAN2#29bis Tdoc G2-060185, 5.3.3.2, “Latency enhancements-System concept (working assumptions),” Ericsson, Siemens, Sophia Antipolis, France, May 22-24, 2006;

3GPP TSG GERAN2#29bis Tdoc G2-060186, “GERAN Evolution—Summary of Application Gains with RTTI and Shorter RRBP,” Ericsson, Sophia Antipolis, France, May 22-26, 2006;

3GPP TSG GERAN2#29bis Tdoc G2-060203, “RTTI and Fast Ack/Nack reporting,” Siemens, Sophia Antipolis, France, May 22-24, 2006; and

3GPP TSG GERAN2#29bis Tdoc G2-060214, Agenda Item 5.3.7, “Support of VoIP in GERAN A/Gb mode,” Nokia, Alcatel, Sophia Antipolis, France, May 22-26, 2006.

The link level performance of (E)GPRS when using the RLC unacknowledged mode is recognized as one limiting factor for providing packet-switched conversational services, such as VoIP, over (E)GPRS. While the RLC unacknowledged mode allows for meeting the stringent delay requirements inherent in the operation of such services, the BLER performance of the RLC unacknowledged mode is low, which tends to restrict its use to those areas having good cellular coverage.

Conversely, the RLC acknowledged mode allows for increasing the link-level performance of (E)GPRS since it allows re-transmissions of incorrectly received RLC/MAC blocks. While the use of re-transmissions increases the probability of correctly receiving RLC/MAC blocks, their use relies on the receipt of acknowledgment (ACK/NACK) messages from the receiver. However, relying on acknowledgment signaling, as currently defined, introduces delays that are generally prohibitive for delay-sensitive traffic. This is true at least for the reason that a RLC/MAC block is re-transmitted by the RLC transmitter if negatively acknowledged (NACKed) by the receiver until it is positively acknowledged (ACKed) by the receiver. Note that the RLC/MAC block structure is defined in Section 10 of 3GPP TS 44.060.

The preemptive re-transmission of a RLC/MAC block is currently possible in (E)GPRS in two cases: a) if there is no new block to transmit and for blocks of which the acknowledgment status is pending; and b) for the last block (see 3GPP TS 44.060 §§9.1.3.2 and 9.3.3.5).

This being the case, a problem is presented if one wishes to employ the preemptive re-transmissions of RLC/MAC blocks when implementing a delay-sensitive service such as, but not limited to, VoIP.

### SUMMARY

In an exemplary aspect of the invention, a method includes: determining whether at least one criterion is fulfilled; transmitting a data block to a receiver; and in response to determining that the at least one criterion is met, preemptively re-transmitting the data block to the receiver.

In another exemplary aspect of the invention, a computer program product includes program instructions embodied on a tangible computer-readable medium. Execution of the program instructions results in operations including: determining whether at least one criterion is fulfilled; transmitting a data block to a receiver; and in response to determining that the at least one criterion is met, preemptively re-transmitting the data block to the receiver.

In a further exemplary aspect of the invention, an electronic device includes: a data processor configured to determine whether at least one criterion is fulfilled; and a transmitter coupled to the data processor and configured to transmit a data block to a receiver of another electronic device, wherein the transmitter is further configured, in response to the data processor determining that the at least one criterion is met, to preemptively re-transmit the data block to the receiver of the other electronic device.

In another exemplary aspect of the invention, an electronic device includes: processing means for determining whether at least one criterion is fulfilled; first transmission means for transmitting a data block to a receiver of another electronic device; and second transmission means for preemptively re-transmitting the data block to the receiver of the other electronic device in response to the processing means determining that the at least one criterion is met.

### BRIEF DESCRIPTION OF THE DRAWINGS

The foregoing and other aspects of embodiments of this invention are made more evident in the following Detailed Description, when read in conjunction with the attached Drawing Figures, wherein:

FIG. 1A shows a simplified block diagram of various electronic devices that are suitable for use in practicing the exemplary embodiments of this invention;

FIGS. 1B and 1C illustrate protocol stacks according to 3GPP TS 23.060 and 3GPP TS 43.064, respectively, which may be employed in the system of FIG. 1A;

FIG. 2 shows the protocol architecture of the RR sublayer and RLC/MAC function, and reproduces FIG. 4.1 of 3GPP TS 44.060;

FIG. 3 illustrates consecutive and parallel re-transmission approaches in accordance with the exemplary embodiments of this invention; and

FIG. 4 is a logic flow diagram that is descriptive of a method, and the operation of a computer program product, in accordance with exemplary embodiments of this invention.

### DETAILED DESCRIPTION

As will be described below, the exemplary embodiments of this invention resolve the foregoing and other problems by combining and exploiting the benefits inherent in both the low delay of RLC unacknowledged mode and the enhanced link level performance of the RLC acknowledged mode.

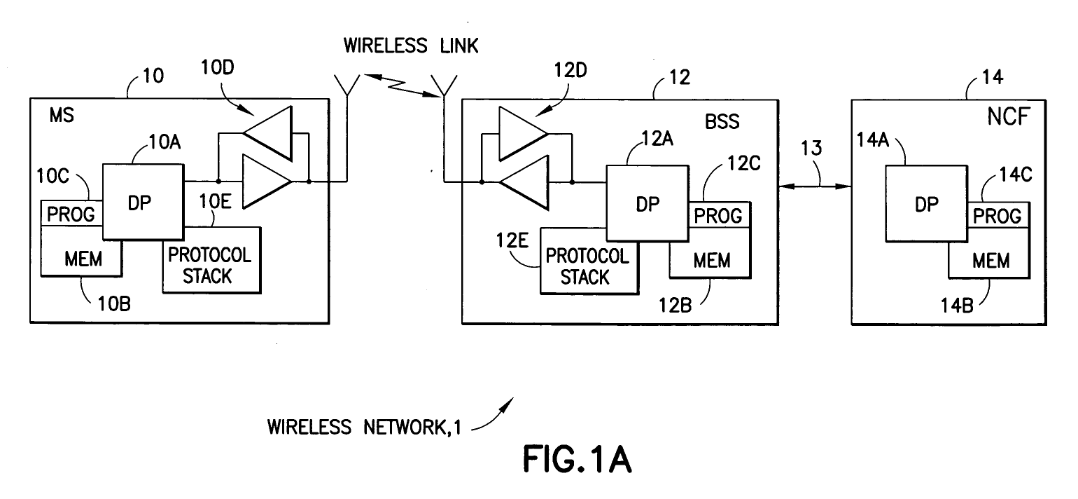

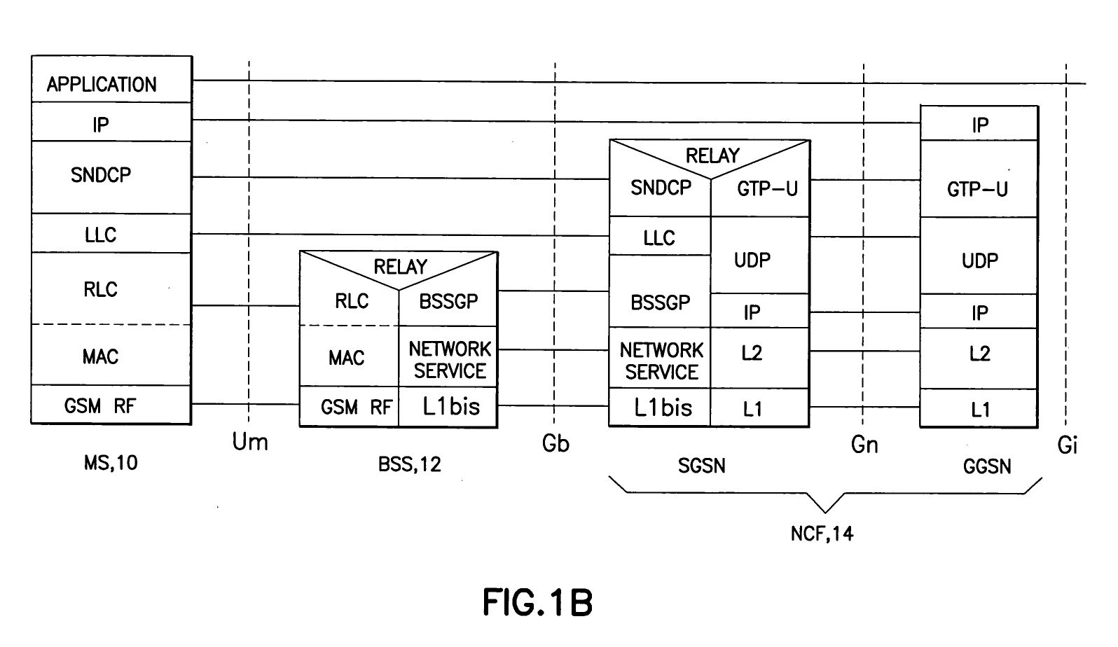

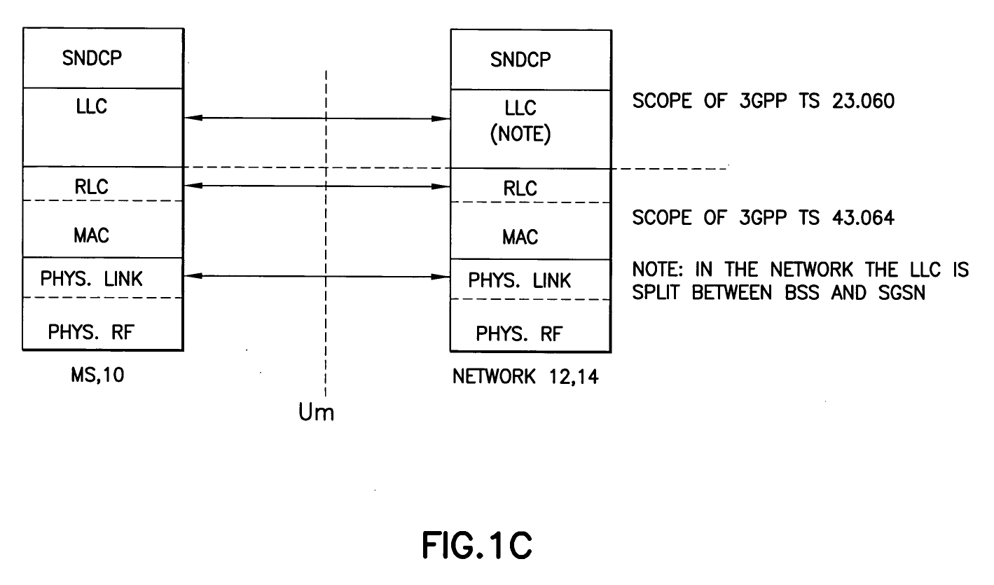

Reference is made first to FIG. 1A for illustrating a simplified block diagram of various electronic devices that are suitable for use in practicing the exemplary embodiments of this invention. In FIG. 1A, a wireless network 1 is adapted for communication with a MS 10 via a BSS 12. The network 1 may include at least one network control function (NCF) 14. The MS 10 includes a data processor (DP) 10A, a memory (MEM) 10B that stores a program (PROG) 10C, and a suitable radio frequency (RF) transceiver 10D for bidirectional wireless communications with the BSS 12, which also includes a DP 12A, a MEM 12B that stores a PROG 12C, and a suitable RF transceiver 12D. The BSS 12 is coupled via a data path 13 to the NCF 14 that also includes a DP 14A and a MEM 14B storing an associated PROG 14C. At least one of the PROGs 10C and 12C is assumed to include program instructions that, when executed by the associated DP, enable the electronic device to operate in accordance with the exemplary embodiments of this invention, as will be discussed below in greater detail.

The MS 10 may be assumed to include and implement a protocol stack 1E, and the BSS 12 may be assumed to include and implement a protocol stack 12E. Reference can be made to FIGS. 1B and 1C for illustrating exemplary functional split for protocol stacks according to 3GPP TS 23.060 and 3GPP TS 43.064, respectively, that may be employed in the system of FIG. 1A to implement the protocol stacks 10E and 12E.

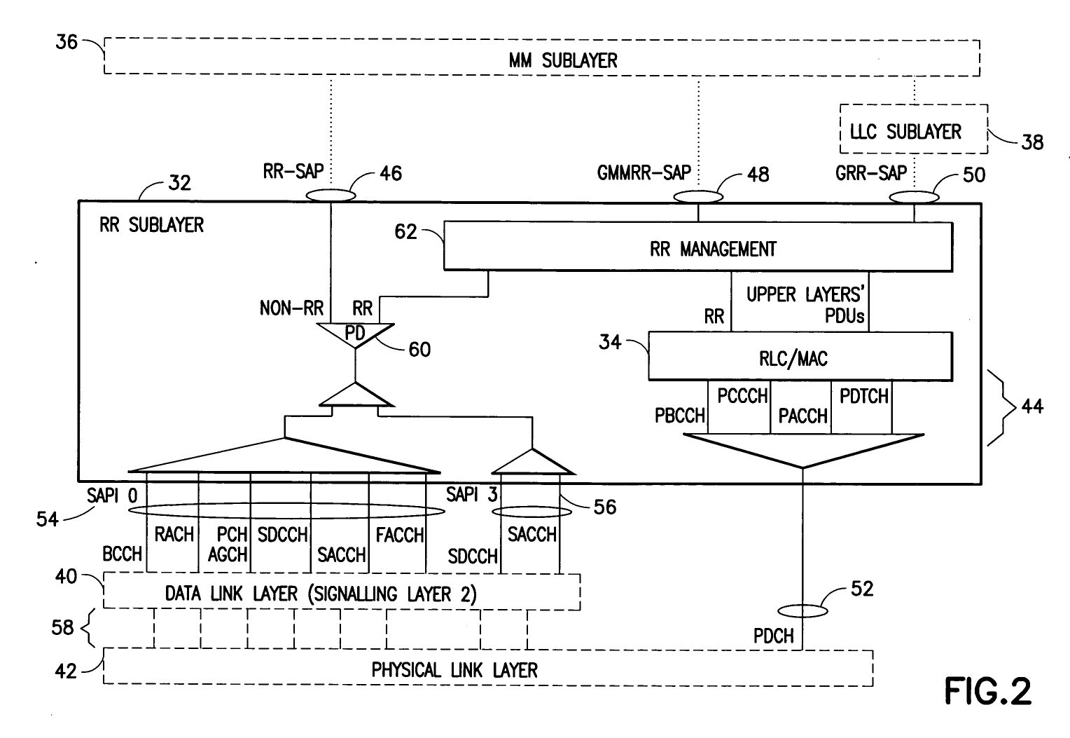

Reference can be made to FIG. 2 for showing in greater detail the protocol architecture of the RR sublayer 32 and RLC/MAC function 34 as currently defined by 3GPP TS 44.060. The RR sublayer 32 provides services to the MM sublayer 36 and the LLC sublayer 38. The RR sublayer 32 utilizes the services of the Data Link layer (signalling layer 2) 40 and the Physical Link layer 42. The packet logical channels PBCCH, PCCCH (including PPCH, PAGCH and PRACH), PACCH and PDTCH 44 are multiplexed onto the packet data physical channels (PDCH 52) on a per radio block basis.

The RR sublayer 32 communicates with the MM sublayer 36 via a RR-SAP 46 and a GMMRR-SAP 48. The RR sublayer 32 communicates with the LLC sublayer 38 via a GRR-SAP 50. The RR sublayer 32 communicates with the Physical Link layer 42 via a PDCH 52. The RR sublayer 32 communicates with the Data Link layer 40 via a SAPI-0 54 and a SAPI-3 56. The SAPI-0 54 includes a BCCH, RACH, AGCH, PCH, SDCCH, SACCH and FACCH. The SAPI-3 56 includes a SDCCH and SACCH. The Data Link layer 40 communicates with the Physical Link layer 42 via data paths 58. Note that the RR sublayer 32 itself includes a PD 60, RR management functions 62 and the RLC/MAC functions 34.

In general, the various embodiments of the MS 10 can include, but are not limited to, cellular telephones, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, as well as portable units or terminals that incorporate combinations of such functions.

The exemplary embodiments of this invention may be implemented by computer software executable by the DP 10A of the MS 10 and the other DPs, or by hardware, or by a combination of software and hardware. The exemplary embodiments of this invention may also be implemented utilizing one or more integrated circuits.

The MEMs 10B, 12B and 14B may be of any type suitable to the local technical environment and may be implemented using any suitable data storage technology, such as semiconductor-based memory devices, magnetic memory devices and systems, optical memory devices and systems, fixed memory and removable memory, as non-limiting examples. The DPs 10A, 12A and 14A may be of any type suitable to the local technical environment, and may include one or more of general purpose computers, special purpose computers, microprocessors, digital signal processors (DSPs) and processors based on a multi-core processor architecture, as non-limiting examples.

The use of the exemplary embodiments of this invention overcome the limitations discussed previously by allowing the transmitter, at any time, to preemptively re-transmit RLC/MAC blocks without necessarily relying on any acknowledgment information from the receiver. This increases the number of correctly received RLC/MAC blocks as compared to the RLC unacknowledged mode, while also considerably decreasing the delay inherent in the use of the RLC acknowledged mode.

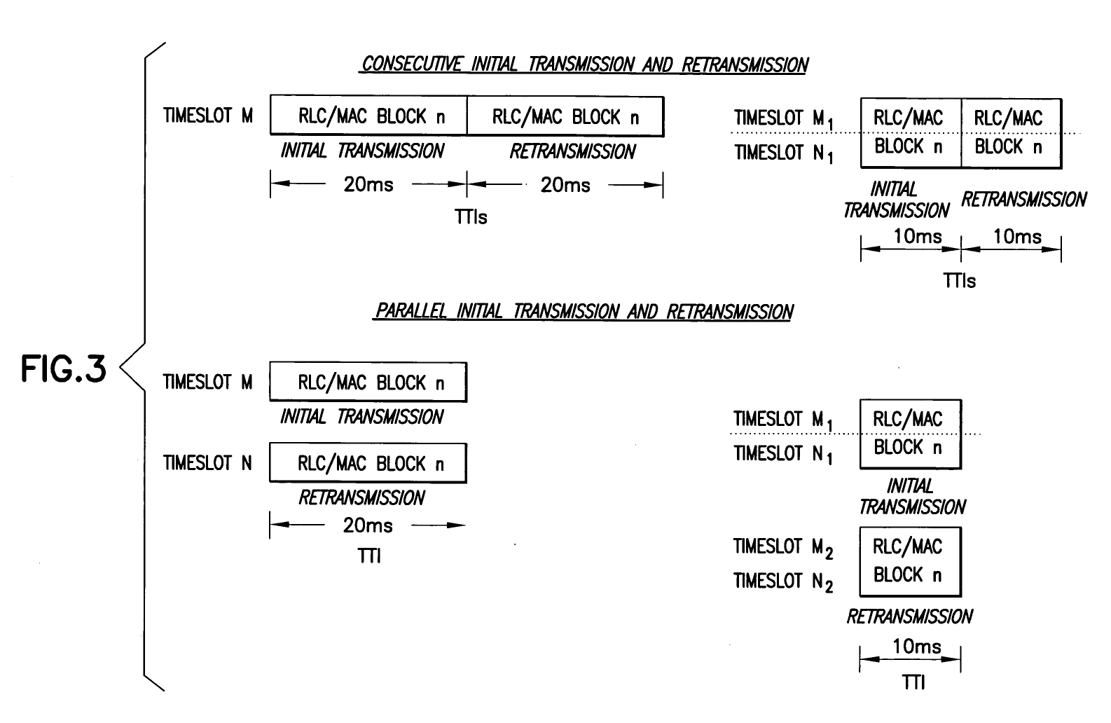

The exemplary embodiments of this invention enable the transmitter to immediately re-transmit a RLC/MAC block, for example, immediately after (consecutively to) an initial transmission of that block (or a re-transmission thereof), or “in parallel” with it, as illustrated in FIG. 3 (e.g., both for the 20 ms TTI and 10 ms TTI options). Note that a 20 ms TTI implies that all four bursts of the RLC/MAC block are sent in the same timeslot, while a 10 ms TTI implies that two bursts of the RLC/MAC block are sent in one timeslot, and the two other bursts are sent in another timeslot. However, it should be realized that the exemplary embodiments of this invention may be used with a transmission interval of any suitable duration.

In accordance with the exemplary embodiments of this invention, there is allowed at least one preemptive re-transmission at a time for a given RLC/MAC block. Note that more than one re-transmission may be made if desired.

As noted above, preemptively re-transmitting a RLC/MAC block is currently possible in (E)GPRS in only the cases where there is no new block to transmit and for blocks of which the acknowledgment status is pending, and for only the very last block.

Parallel Preemptive Re-Transmission

The use of parallel re-transmission enables maintaining the transmission time of a RLC/MAC block and its pre-emptive re-transmission within one TTI. Considering a given radio resource pool being used for a RLC/MAC block within a TTI, the parallel re-transmission approach requires a second radio resource pool within the same TTI, as shown in FIG. 3. For example, if a single timeslot were used for the RLC unacknowledged mode operation (TTI=20 ms), then the use of the preemptive (anytime) parallel re-transmission requires a two-timeslot assignment to the transmitter and receiver, and within that TTI one timeslot would be used for the initial transmission (or re-transmission thereof) and the other timeslot would be used for the corresponding preemptive re-transmission.

Consecutive Pre-Emptive Re-Transmission

Consecutive re-transmission implies transmitting a RLC/MAC block, and its corresponding preemptive re-transmission, within two TTIs, while using a single radio resource pool per TTI.

Criteria for Pre-Emptive Re-Transmission

A number of criteria may be used for determining when to transmit an anytime preemptive re-transmission. These criteria may include, but are not limited to, the estimated link quality, the content and/or the priority of the RLC/MAC block (if known).

Combination of Anytime Preemptive Re-Transmission with Existing RLC Modes

The anytime preemptive re-transmission in accordance with the exemplary embodiments of this invention is inherently combinable with all current RLC modes with but minor modifications: RLC unacknowledged mode, RLC acknowledged mode and RLC non-persistent mode (see 3GPP TS 44.060) so as to, for example, considerably improve the link performance of the RLC unacknowledged mode and the RLC non-persistent mode, as well as to reduce the delays of the RLC acknowledged mode.

It should be noted that the use of the exemplary embodiments may be made by the MS 10 for preemptively re-transmitting a RLC/MAC block to the BSS 12, and by the BSS 12 for preemptively re-transmitting a RLC/MAC block to the MS 10. Note that the original and re-transmitted RLC/MAC blocks each carry the same BSN (per 3GPP TS 44.060 §10.4.12).

Note that some signaling may be used to enable preemptive re-transmission. This signaling could be provided, for example, by the network to the MS at TBF assignment.

Further, no new signaling is needed to allocate the additional resources, as existing signaling can be employed for this purpose. For example, if the network desires to make use of parallel preemptive re-transmission, the network ensures that sufficient resources are assigned to make this possible (e.g., at TBF assignment). The network may assign, for example, two timeslots for a TBF but dynamically allocate the two timeslots to that TBF. That is, the network may determine for a given block period to use the two timeslots, or to only use one of them. For example, if the network assigns a downlink TBF on two timeslots, this implies that the MS 10 should monitor the two assigned timeslots for receiving RLC/MAC blocks for that TBF. However, the network does not have to use both of the assigned timeslots at any given time, and it may dynamically allocate a block period to that mobile station on any one, or both, of the assigned timeslots. For an uplink TBF, the network uses the USF in the downlink to dynamically indicate which timeslots the MS should use at a given time in the uplink.

Based on the foregoing it should be apparent that the exemplary embodiments of this invention provide a method, apparatus, devices (including integrated circuit embodiments) and computer program product(s) to send a data block from a transmitter to a receiver.

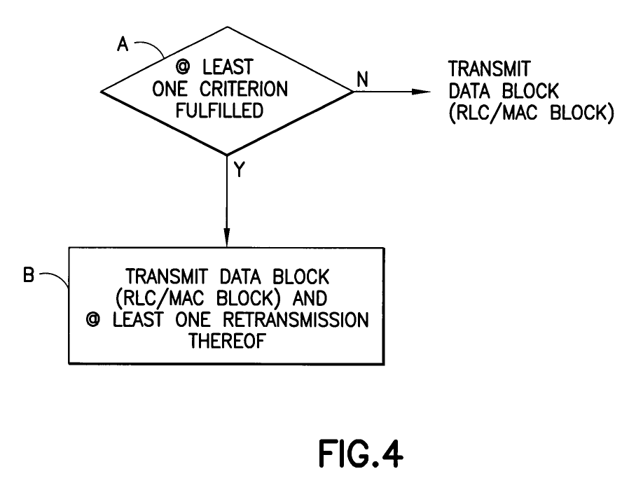

Referring also to FIG. 4, and in accordance with a non-limiting example of a method, at Step A, a determination is made that at least one criterion is fulfilled, and at Step B a current data block is transmitted and then preemptively re-transmitted, at least once, to a receiver using one of, for example, the consecutive or parallel re-transmission schemes described above.

It should be appreciated that the logical flow of steps shown in FIG. 4 is merely exemplary and non-limiting. The exemplary embodiments of the invention may utilize a different sequence of steps. For example, in another exemplary embodiment, a current data block is transmitted. Subsequently, it is determined whether at least one criterion is fulfilled. If the at least one criterion is fulfilled, the current data block is preemptively re-transmitted, at least once, to a receiver using one of, for example, the consecutive or parallel re-transmission schemes described above. In such an exemplary embodiment, it should be appreciated that the at least one criterion does not comprise receipt of an acknowledgement message (e.g., a NACK).

In accordance with a non-limiting example of a computer program product, a data processor is operated so as to make a determination that at least one criterion is fulfilled, and to transmit a current data block and to preemptively re-transmit the data block, at least once, to a receiver using one of, for example, the consecutive or parallel re-transmission schemes described above.

In accordance with a non-limiting example of an apparatus, a device includes a unit to make a determination that at least one criterion is fulfilled, and a unit to transmit a current data block and to preemptively re-transmit the data block, at least once, to a receiver using one of, for example, the consecutive or parallel re-transmission schemes described above.

In accordance with a further non-limiting example of an apparatus, an electronic device includes: processing means for determining whether at least one criterion is fulfilled; first transmission means for transmitting a data block to a receiver of another electronic device; and second transmission means for preemptively re-transmitting the data block to the receiver of the other electronic device in response to the processing means determining that the at least one criterion is met. In other exemplary embodiments, the processing means comprises a data processor, the first transmission means comprises a transmitter and the first transmission means comprises the second transmission means. In further exemplary embodiments, preemptively re-transmitting the data block comprises using one of a consecutive re-transmission scheme or a parallel re-transmission scheme. In other exemplary embodiments, the electronic device comprises one of a mobile station or a base station.

The exemplary embodiments of the invention, as discussed above and as particularly described with respect to exemplary methods, may be implemented as a computer program product comprising program instructions embodied on a tangible computer-readable medium. Execution of the program instructions results in operations comprising steps of utilizing the exemplary embodiments or steps of the method.

While the exemplary embodiments have been described above in the context of the (E)GPRS system, it should be appreciated that the exemplary embodiments of this invention are not limited for use with only this one particular type of wireless communication system, and that they may be used to advantage in other wireless communication systems.

In general, the various exemplary embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the exemplary embodiments of this invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The exemplary embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

Programs, such as those provided by Synopsys, Inc. of Mountain View, Calif. and Cadence Design, of San Jose, Calif. automatically route conductors and locate components on a semiconductor chip using well established rules of design as well as libraries of pre-stored design modules. Once the design for a semiconductor circuit has been completed, the resultant design, in a standardized electronic format (e.g., Opus, GDSII, or the like) may be transmitted to a semiconductor fabrication facility or “fab” for fabrication.

Various modifications and adaptations to the foregoing exemplary embodiments of this invention may become apparent to those skilled in the relevant arts in view of the foregoing description, when read in conjunction with the accompanying drawings. For example, re-transmission schemes other than the consecutive/parallel schemes as described above may employed. However, any and all modifications will still fall within the scope of the non-limiting and exemplary embodiments of this invention.

Furthermore, some of the features of the various non-limiting and exemplary embodiments of this invention may be used to advantage without the corresponding use of other features. As such, the foregoing description should be considered as merely illustrative of the principles, teachings and exemplary embodiments of this invention, and not in limitation thereof.

What is claimed is:

1. A method comprising:
determining whether at least one criterion is fulfilled;
transmitting a data block to a receiver; and
in response to determining that the at least one criterion is met, preemptively re-transmitting the data block to the receiver.

2. The method of claim 1, wherein preemptively re-transmitting the data block comprises using one of a consecutive re-transmission scheme or a parallel re-transmission scheme.

3. The method of claim 1, wherein preemptively re-transmitting the data block comprises using a consecutive re-transmission scheme, wherein transmitting the data block comprises transmitting the data block in a first transmission timing interval (TTI) using a resource, wherein preemptively re-transmitting the data block comprises re-transmitting the data block in a second TTI using the resource.

4. The method of claim 1, wherein preemptively re-transmitting the data block comprises using a parallel re-transmission scheme, wherein transmitting the data block comprises transmitting the data block in a transmission timing interval (TTI) using a first resource, wherein preemptively re-transmitting the data block comprises re-transmitting the data block in the TTI using a second resource.

5. The method of claim 1, wherein the at least one criterion comprises at least one of an estimated link quality, a content of the data block and a priority of the data block.

6. The method of claim 1, wherein the data block comprises a radio link control/medium access control (RLC/MAC) block.

7. The method of claim 1, wherein the preemptive re-transmission is combinable with a radio link control (RLC) unacknowledged mode, a RLC acknowledged mode and a RLC non-persistent mode.

8. The method of claim 1, wherein the re-transmitted data block has a same block sequence number as the transmitted data block.

9. The method of claim 1, further comprising: signaling from a first station to a second station to enable the preemptive re-transmission.

10. The method of claim 1, further comprising: allocating at least one resource for the preemptive re-transmission of the data block.

11. The method of claim 10, wherein the allocated at least one resource comprises at least one of an additional timeslot and an additional channel.

12. The method of claim 1, wherein the receiver comprises a component of a station in an enhanced general packet radio services ((E)GPRS) system.

13. A computer program product comprising program instructions embodied on a tangible computer-readable medium, execution of the program instructions resulting in operations comprising:
determining whether at least one criterion is fulfilled;
transmitting a data block to a receiver; and
in response to determining that the at least one criterion is met, preemptively re-transmitting the data block to the receiver.

14. The computer program product of claim 13, wherein preemptively re-transmitting the data block comprises using one of a consecutive re-transmission scheme or a parallel re-transmission scheme.

15. The computer program product of claim 13, wherein preemptively re-transmitting the data block comprises using a consecutive re-transmission scheme, wherein transmitting the data block comprises transmitting the data block in a first transmission timing interval (TTI) using a resource, wherein preemptively re-transmitting the data block comprises re-transmitting the data block in a second TTI using the resource.

16. The computer program product of claim 13, wherein preemptively re-transmitting the data block comprises using a parallel re-transmission scheme, wherein transmitting the data block comprises transmitting the data block in a transmission timing interval (TTI) using a first resource, wherein preemptively re-transmitting the data block comprises re-transmitting the data block in the TTI using a second resource.

17. The computer program product of claim 13, wherein the at least one criterion comprises at least one of an estimated link quality, a content of the data block and a priority of the data block.

18. The computer program product of claim 13, wherein the data block comprises a radio link control/medium access control (RLC/MAC) block.

19. The computer program product of claim 13, wherein the preemptive re-transmission is combinable with a radio link control (RLC) unacknowledged mode, a RLC acknowledged mode and a RLC non-persistent mode.

20. The computer program product of claim 13, wherein the re-transmitted data block has a same block sequence number as the transmitted data block.

21. The computer program product of claim 13, wherein execution of the program instructions results in operations further comprising: signaling from a first station to a second station to enable the preemptive re-transmission.

22. The computer program product of claim 13, wherein execution of the program instructions results in operations further comprising: allocating at least one resource for the preemptive re-transmission of the data block.

23. The computer program product of claim 22, wherein the allocated at least one resource comprises at least one of an additional timeslot and an additional channel.

24. The computer program product of claim 13, wherein the receiver comprises a component of a station in an enhanced general packet radio services ((E)GPRS) system.

25. An electronic device comprising:
a data processor configured to determine whether at least one criterion is fulfilled; and
a transmitter coupled to the data processor and configured to transmit a data block to a receiver of another electronic device, wherein the transmitter is further configured, in response to the data processor determining that the at least one criterion is met, to preemptively re-transmit the data block to the receiver of the other electronic device.

26. The electronic device of claim 25, wherein the transmitter is configured to preemptively re-transmit the data block using one of a consecutive re-transmission scheme or a parallel re-transmission scheme.

27. The electronic device of claim 25, wherein the at least one criterion comprises at least one of an estimated link quality, a content of the data block and a priority of the data block.

28. The electronic device of claim 25, wherein the data processor is further configured to allocate at least one resource for the preemptive re-transmission of the data block.

29. The electronic device of claim 25, wherein the electronic device comprises a station in an enhanced general packet radio services ((E)GPRS) system.

30. The electronic device of claim 25, wherein the electronic device comprises a mobile station.

31. The electronic device of claim 25, wherein the electronic device comprises a base station.

32. An electronic device comprising:
processing means for determining whether at least one criterion is fulfilled;
first transmission means for transmitting a data block to a receiver of another electronic device; and
second transmission means for preemptively re-transmitting the data block to the receiver of the other electronic device in response to the processing means determining that the at least one criterion is met.

33. The electronic device of claim 32, wherein the processing means comprises a data processor, wherein the first transmission means comprises a transmitter, wherein the first transmission means comprises the second transmission means.

34. The electronic device of claim 32, wherein preemptively re-transmitting the data block comprises using one of a consecutive re-transmission scheme or a parallel re-transmission scheme.

35. The electronic device of claim 32, wherein the electronic device comprises one of a mobile station or a base station.
